(19) United States
(12) Patent Application Publication
(10) Pub. No.: US 2009/0178010 A1
(43) Pub. Date: Jul. 9, 2009

(54) Specifying Language and Other Preferences for Mobile Device Applications

(75) Inventor: Imran A. Chaudhri, San Francisco, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/208,268

(22) Filed: Sep. 10, 2008

Related U.S. Application Data
(60) Provisional application No. 61/019,271, filed on Jan. 6, 2008.

(51) Int. Cl. G06F 3/033; G06F 17/20

(52) U.S. Cl. 715/863; 704/8

(57) ABSTRACT

A user interface for specifying a preference for content is displayed over the content on a display of a mobile device. Preferences (e.g., language preferences) can be specified for audio, closed captions, subtitles and any other features or operations associated with the mobile device. In one aspect, the user interface is a partially transparent sheet that at least partially overlies the content. The sheet can be navigated (e.g., scrolled) in response to input (e.g., touch input). In one aspect, the specified option is made a default option for at least some other applications running on the mobile device. In one aspect, the content is video which is automatically paused while the user interface is displayed.

### RELATED APPLICATION

This application claims priority from U.S. Provisional Application No. 61/019,271, dated Jan. 6, 2008, entitled “Specifying Language and Other Preferences for Mobile Device Applications”, which provisional application is incorporated by reference herein in its entirety.

### TECHNICAL FIELD

The subject matter of this application relates generally to user interfaces.

### BACKGROUND

A video can include subtitles or closed captions. The subtitles or closed captions can provide a translation or a transcript of the spoken dialogue in a video and optionally other information. Closed captions are useful to hearing impaired viewers. Subtitles are useful for viewing foreign language videos or for viewing videos in a noisy environment. Subtitles and closed captions can obscure video content when displayed on mobile devices with a limited display area.

### SUMMARY

A user interface for specifying a preference for content is displayed over the content on a display of a mobile device. Preferences (e.g., language preferences) can be specified for audio, closed captions, subtitles and any other features or operations associated with the mobile device. In one aspect, the user interface is a partially transparent sheet that at least partially overlies the content. The sheet can be navigated (e.g., scrolled) in response to input (e.g., touch input). In one aspect, the specified option is made a default option for at least some other applications running on the mobile device. In one aspect, the content is video which is automatically paused while the user interface is displayed.

### BRIEF DESCRIPTION OF THE DRAWINGS

FIG. 1 is a block diagram of an example mobile device.

FIG. 2 illustrates an example of content playing in full screen mode on a display of the mobile device of FIG. 1, including an overlying partially transparent navigation panel.

FIG. 3A illustrates an example of video content played in full screen mode, including an overlying and partially transparent option sheet.

FIG. 3B illustrates an example of video content played in full screen mode, including a language selection box responsive to touch input.

FIG. 4 is a flow diagram of an example process for displaying language options on the mobile device of FIG. 1.

FIG. 5 is a block diagram of an example architecture of the mobile device of FIG. 1.

FIG. 6 is a block diagram of an example network operating environment for the mobile device of FIG. 1.

### DETAILED DESCRIPTION

### Example Mobile Device

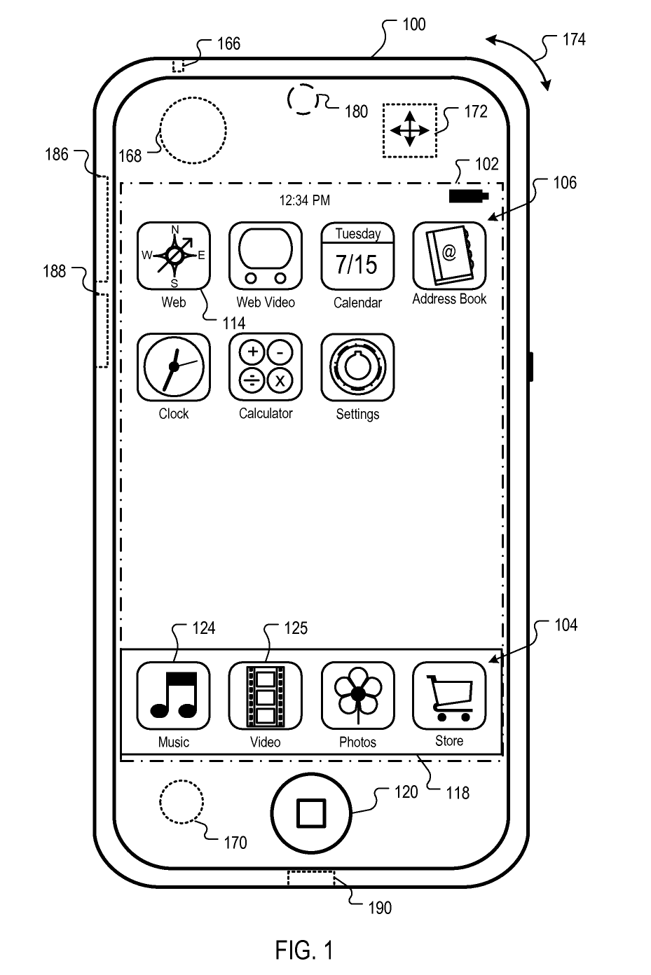

FIG. 1 is a block diagram of an example mobile device 100. The mobile device 100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

In some implementations, the mobile device 100 includes a touch-sensitive display 102. The touch-sensitive display 102 can implement liquid crystal display (LCD) technology, light emitting polymer display (LPD) technology, or some other display technology. The touch-sensitive display 102 can be sensitive to haptic and/or tactile contact with a user.

In some implementations, the touch-sensitive display 102 can comprise a multi-touch-sensitive display 102. A multi-touch-sensitive display 102 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 100 can display one or more graphical user interfaces on the touch-sensitive display 102 for providing the user access to various system objects and for conveying information to the user. In the example shown, display objects 106 are graphic representations of system objects. Some examples of system objects include device functions, applications, windows, files, alerts, events, etc.

### Example Mobile Device Functionality

In some implementations, the mobile device 100 can perform multiple applications, including but not limited to: telephony, e-mail, data communications and media processing. In some implementations, display objects 106 can be presented in a menu bar or “dock” 118. In the example shown, the dock 118 includes music and video display objects 124, 125. In some implementations, system objects can be accessed from a top-level graphical user interface or “home” screen by touching a corresponding display object 104, 106. A mechanical button 120 can be used to return the user to the “home” screen.

In some implementations, upon invocation of an application, the touch screen 102 changes, or is augmented or replaced, with another user interface or user interface elements, to facilitate user access to particular functions associated with a selected application. For example, in response to a user touching the Web object 114 the graphical user interface can present user interface elements related to Web-surfing.

In some implementations, the mobile device 100 can include one or more input/output (I/O) devices and/or sensors. For example, a speaker and a microphone can be included to facilitate voice-enabled functionalities, such as phone and voice mail functions. In some implementations, an up/down button for volume control of the speaker and the microphone can be included. The mobile device 100 can also include an on/off button for a ring indicator of incoming phone calls. In some implementations, a loud speaker can be included to facilitate hands-free voice functionalities, such as speaker phone functions. An audio jack 166 can also be included for use of headphones and/or a microphone.

In some implementations, a proximity sensor 168 can be included to facilitate the detection of the user positioning the mobile device 100 proximate to the user's ear and, in response, to disengage the touch-sensitive display 102 to prevent accidental function invocations. In some implementations, the touch-sensitive display 102 can be turned off to conserve additional power when the mobile device 100 is proximate to the user's ear.

Other sensors can also be used. For example, in some implementations, an ambient light sensor 170 can be utilized to facilitate adjusting the brightness of the touch-sensitive display 102. In some implementations, an accelerometer 172 can be utilized to detect movement of the mobile device 100, as indicated by the directional arrow 174. Display objects and/or media can be presented according to a detected orientation, e.g., portrait or landscape. In some implementations, the mobile device 100 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 100 or provided as a separate device that can be coupled to the mobile device 100 through an interface (e.g., port device 190) to provide access to location-based services.

In some implementations, a port device 190, e.g., a Universal Serial Bus (USB) port, or a docking port, or some other wired port connection, can be included. The port device 190 can, for example, be utilized to establish a wired connection to other computing devices, such as other mobile devices, network access devices, a personal computer, a printer, a display screen, or other processing devices capable of receiving and/or transmitting data. In some implementations, the port device 190 allows the mobile device 100 to synchronize with a host device using one or more protocols, such as, for example, the TCP/IP, HTTP, UDP and any other known protocol.

The mobile device 100 can also include a camera lens and sensor 180. In some implementations, the camera lens and sensor 180 can be located on the back surface of the mobile device 100. The camera can capture still images and/or video.

The mobile device 100 can also include one or more wireless communication subsystems, such as an 802.11b/g communication device 186, and/or a Bluetooth™ communication device 188. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

### Example Navigation Panel Overlay

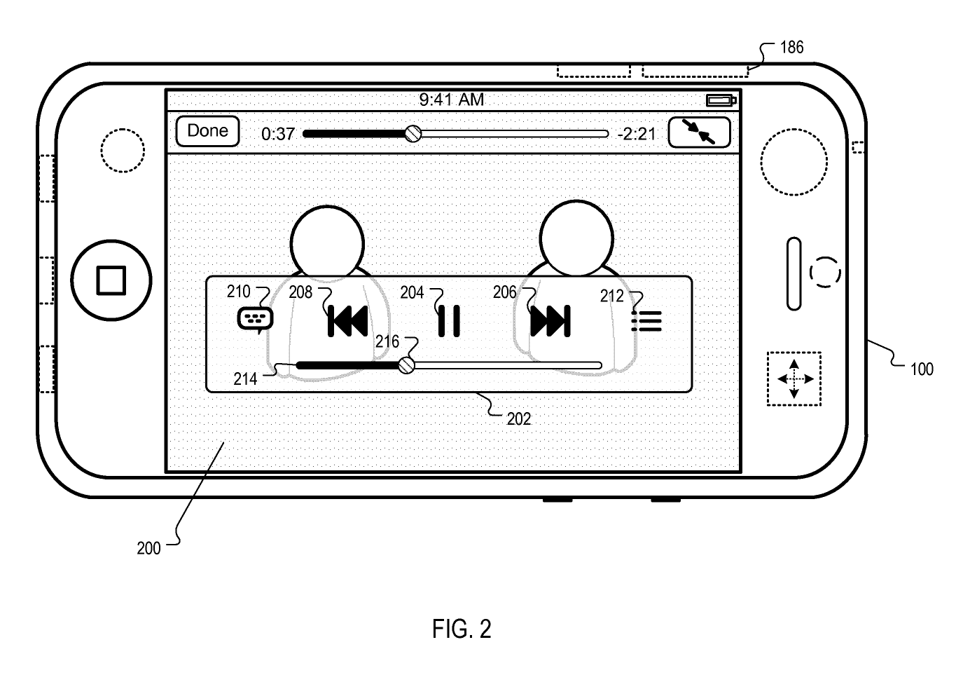

FIG. 2 illustrates an example of content playing in full screen mode on a display 200 of the mobile device 100 of FIG. 1, including an overlying and partially transparent navigation panel 202 or “heads up” display. The navigation panel 202 can contain one or more navigation elements which can be used to invoke navigation operations on the currently playing content (e.g., video, slideshow, keynote presentation, television broadcast, webcast, videocast). In some implementations, the navigation panel 202 can be at least partially transparent such that the underlying content (e.g., currently playing video content) can be seen.

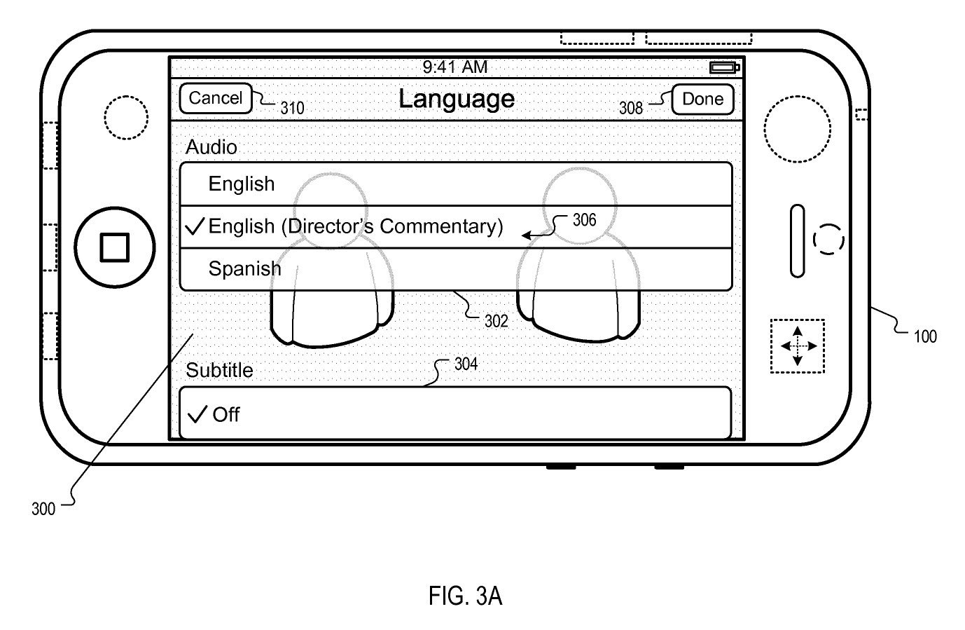

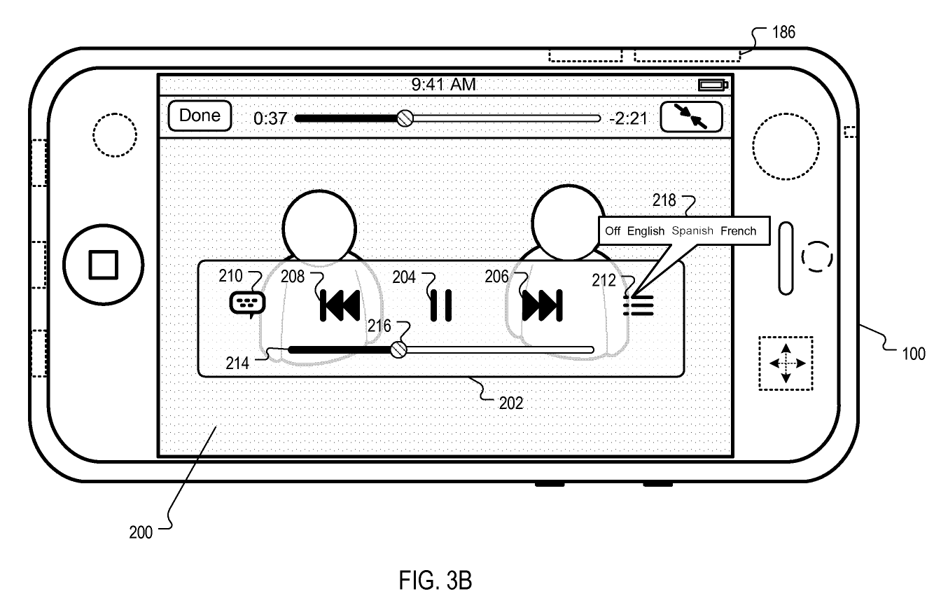

In the example shown, the user is viewing video content and the navigation panel 202 includes a navigation element 204 for playing or pausing the video, a navigation element 206 for forwarding the video and a navigation element 208 for reversing the video. The user can turn closed captioning on or off by touching a closed captioning element 210. The user can specify a language preference by touching a language menu element 212 to invoke a language option sheet 300, as described in reference to FIG. 3. The navigation panel 202 may also contain a scrubber 214 with a handle 216 which can be used to navigate the video.

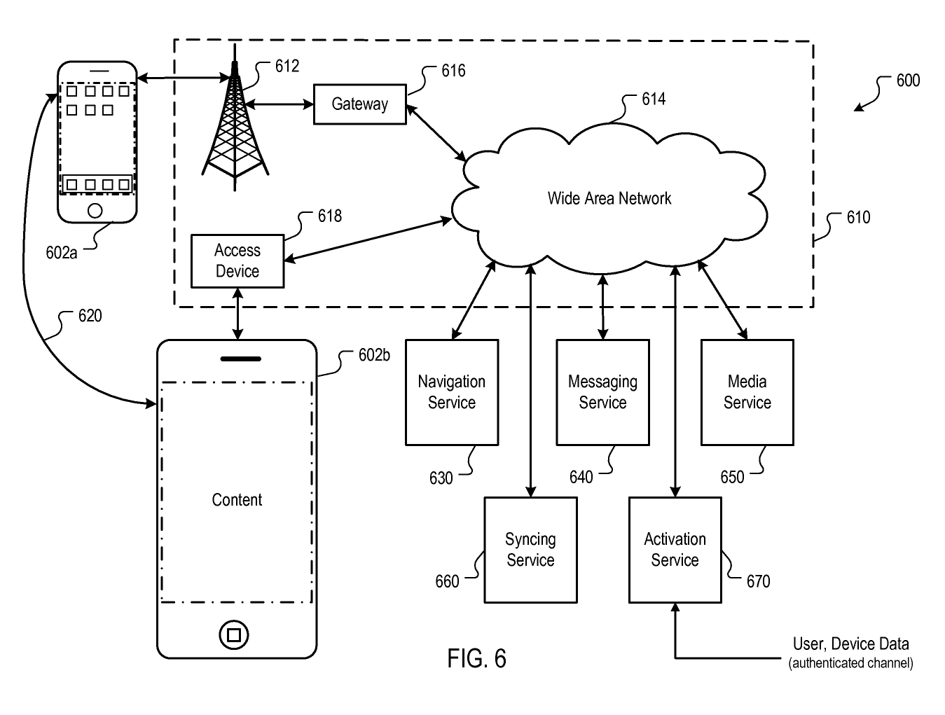

The video content can be stored on the mobile device 100 or streamed to the mobile device from a media service 640, as described in reference to FIG. 6. In some implementations, the video content can be a television broadcast, videocast, webcast, Internet broadcast, etc. In some implementations, the language option sheet 300 described in reference to FIG. 3 can be generated by a service (e.g., by a cable headend) or a set-top box.

### Example Language Option Sheet

FIG. 3A illustrates an example of a video played in full screen mode, including an overlying and partially transparent option sheet 300. The option sheet 300 includes a display element 302 showing language options for audio associated with the currently playing video. In the example shown, the language options include English, English (Director's Commentary), and Spanish. Other languages can also be included as options (e.g., French, German).

The option sheet 300 also includes a display element 304 showing options for subtitles associated with the currently playing video. Options for subtitles can include options for color, fonts and styles for the subtitles in addition to language. For example, the user can select an option to show the subtitles in a frame surround the video (e.g., letterbox mode) or overlying the video (e.g., full screen mode). In some implementations, other display elements presenting additional options may not fit on the screen. In such implementations, the viewer can scroll the sheet 300 using touch gestures so that the hidden display elements can be viewed and accessed by the viewer. The scrolling can be up or down or from side to side. In some implementations, the scrolling speed can be adjusted based on viewer input (e.g., touch input). For example, if the viewer gestures more quickly or more slowly the scrolling speed will increase or decrease, respectively.

In some implementations, a visual indicator (e.g., a check symbol) adjacent to option 306 (e.g., a text or image item) within display element 302 can indicate the viewer's currently selected audio option. In the example shown, the viewer selected English (Director's Commentary), as indicated by the check symbol adjacent the option 306. A user may select a different language by touching the corresponding option in the display element 302. Upon selecting a different option, the audio associated with the video will be played in the different selected language.

In some implementations, the selected language or option is applied globally on the mobile device 100 as a default language or option for other applications running on the mobile device 100. For example, if the user chooses to play a different video, a language selection may persist from the previously played video.

When a viewer is finished choosing language options, the viewer may select the “Done” button 308 to remove the sheet 300 from the touch screen and to retain their selected options. If a viewer does not wish to retain their selected options, or wishes to exit the sheet 300 without selecting an option, the viewer can select the “Cancel” button 310. In some other implementations, the functionality of the “Done” element 308 and the “Cancel” button 310 may be replicated by a tap sequence or gesture using one or more fingers, or by some other method(s), user interface element and/or input device.

FIG. 3B illustrates an example of video content played in full screen mode, including a language selection box 218 responsive to touch input. In some implementations, when the viewer touches the language menu element 212 the language selection box 218 appears. The viewer can then drag their finger across language options. As each option is traversed by the finger it highlights or otherwise changes its visual appearance to indicate its selection. When the viewer removes their finger from the touch screen the currently highlighted language is selected and the selection box 218 disappears. Thus in a single and continuous gesture a language for subtitles can be selected without the user removing their finger from the touch screen.

### Example Process For Displaying Subtitles

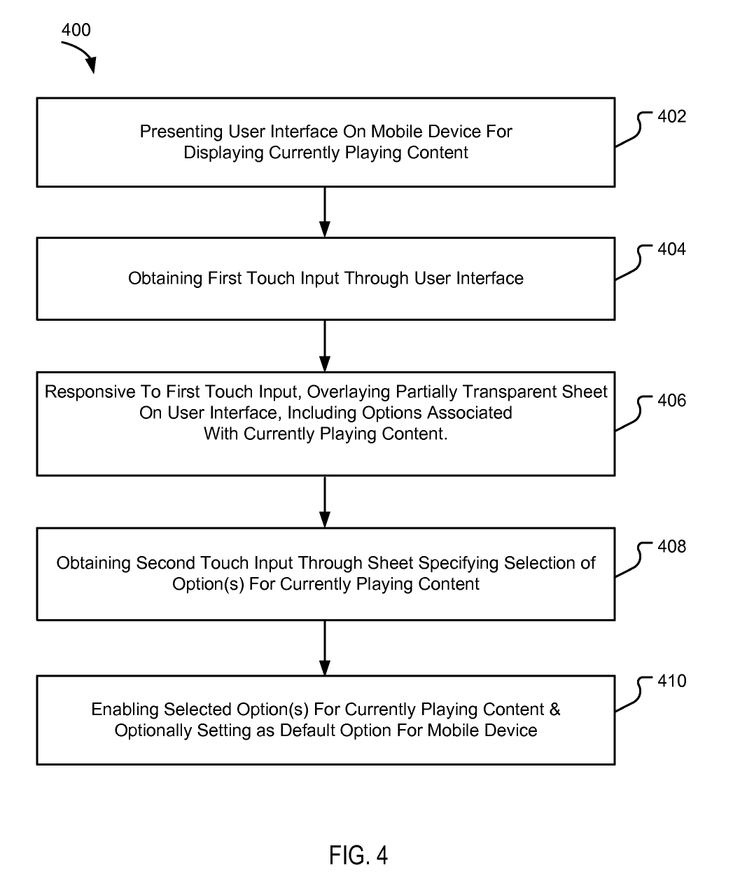

FIG. 4 is a flow diagram of an example process 400 for displaying language options on the mobile device of FIG. 1. The process 400 can be performed by one or more processors or processing cores executing instructions stored in a computer program product, such as mobile device 100 executing media processing instructions.

The process 400 begins by presenting a user interface on a mobile device for displaying currently playing content (402). For example, the user interface can be presented on the touch screen 102 of mobile device 100. The user interface can be provided by the mobile device or by another device (e.g., a media service). The user interface can be presented in response to user actions on the device, including in response to touch input (e.g., one or more taps or gestures).

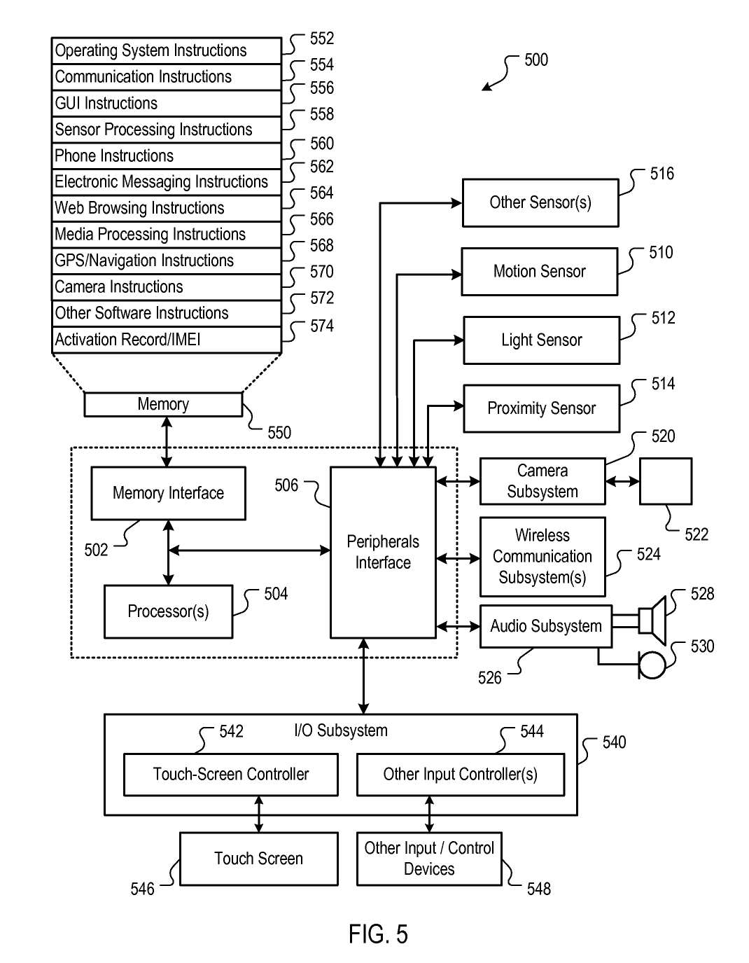

A first touch input can be obtained through the user interface (404). For example, touch input can be obtained using sensor processing instructions 558 executing in mobile device 100, as described in reference to FIG. 5. Responsive to the first touch, a partially transparent sheet is overlaid on the user interface which includes options (e.g., language options) associated with the current playing content (406). For example, the partially transparent sheet can be sheet 300 which includes display elements 302, 304 for presenting options, as described in reference to FIG. 3. The partially transparent sheet can appear in response to the viewer tapping the touch screen or gesturing using one or more fingers or a stylus. The partially transparent sheet can be animated to slide in from the top, bottom or sides of a content display in both portrait and landscape display formats.

A second touch input is obtained through the partially transparent sheet specifying selection of an option for currently playing content (408). For example, the viewer can select a language option for video content from display elements 302, 304 by tapping a text or image item corresponding to the option.

The selected option for the currently playing content is enabled and optionally set as a default option for the mobile device (410). For example, a selected language will become a global language that can be used by other applications running on the mobile device. In some implementations, the selected language will become the default language only for mobile device applications where the user has not previously selected a language preference for the application. This feature prevents viewer-selected language options from being superseded unintentionally.

### Example Mobile Device Architecture

FIG. 5 is a block diagram of an example architecture 500 of the mobile device 100 of FIG. 1. The mobile device 100 can include a memory interface 502, one or more data processors, image processors and/or central processing units 504, and a peripherals interface 506. The memory interface 502, the one or more processors 504 and/or the peripherals interface 506 can be separate components or can be integrated in one or more integrated circuits. The various components in the mobile device 100 can be coupled by one or more communication buses or signal lines.

Sensors, devices, and subsystems can be coupled to the peripherals interface 506 to facilitate multiple functionalities. For example, a motion sensor 510, a light sensor 512, and a proximity sensor 514 can be coupled to the peripherals interface 506 to facilitate the orientation, lighting, and proximity functions described with respect to FIG. 1. Other sensors 516 can also be connected to the peripherals interface 506, such as a positioning system (e.g., GPS receiver), a temperature sensor, a biometric sensor, or other sensing device, to facilitate related functionalities.

A camera subsystem 520 and an optical sensor 522, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 524, which can include radio frequency receivers and transmitters and/or optical (e.g., infrared) receivers and transmitters. The specific design and implementation of the communication subsystem 524 can depend on the communication network(s) over which the mobile device 100 is intended to operate. For example, a mobile device 100 may include communication subsystems 524 designed to operate over a GSM network, a GPRS network, an EDGE network, a Wi-Fi or WiMax network, and a Bluetooth™ network. In particular, the wireless communication subsystems 524 may include hosting protocols such that the device 100 may be configured as a base station for other wireless devices.

An audio subsystem 526 can be coupled to a speaker 528 and a microphone 530 to facilitate voice-enabled functions, such as voice recognition, voice replication, digital recording, and telephony functions.

The I/O subsystem 540 can include a touch screen controller 542 and/or other input controller(s) 544. The touch-screen controller 542 can be coupled to a touch screen 546. The touch screen 546 and touch screen controller 542 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 546.

The other input controller(s) 544 can be coupled to other input/control devices 548, such as one or more buttons, rocker switches, thumb-wheel, infrared port, USB port, and/or a pointer device such as a stylus. The one or more buttons (not shown) can include an up/down button for volume control of the speaker 528 and/or the microphone 530.

In one implementation, a pressing of the button for a first duration may disengage a lock of the touch screen 546; and a pressing of the button for a second duration that is longer than the first duration may turn power to the mobile device 100 on or off. The user may be able to customize a functionality of one or more of the buttons. The touch screen 546 can, for example, also be used to implement virtual or soft buttons and/or a keyboard.

In some implementations, the mobile device 100 can present recorded audio and/or video files, such as MP3, AAC, and MPEG files. In some implementations, the mobile device 100 can include the functionality of an MP3 player, such as an iPod Touch™.

The memory interface 502 can be coupled to memory 550. The memory 550 can include high-speed random access memory and/or non-volatile memory, such as one or more magnetic disk storage devices, one or more optical storage devices, and/or flash memory (e.g., NAND, NOR). The memory 550 can store an operating system 552, such as Darwin, RTXC, LINUX, UNIX, OS X, WINDOWS, or an embedded operating system such as VxWorks. The operating system 552 may include instructions for handling basic system services and for performing hardware dependent tasks. In some implementations, the operating system 552 can be a kernel (e.g., UNIX kernel).

The memory 550 may also store communication instructions 554 to facilitate communicating with one or more additional devices, one or more computers and/or one or more servers. The memory 550 may include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic-messaging related processes and functions; web browsing instructions 564 to facilitate web browsing-related processes and functions; media processing instructions 566 to facilitate media processing-related processes and functions; GPS/Navigation instructions 568 to facilitate GPS and navigation-related processes and instructions; camera instructions 570 to facilitate camera-related processes and functions; and/or other software instructions 572 to facilitate other processes and functions, e.g., security processes and functions. In some implementations, the GUI instructions 556 and/or the media processing instructions 566 implement the features and operations described in reference to FIGS. 1-4.

The memory 550 may also store other software instructions (not shown), such as web video instructions to facilitate web video-related processes and functions; and/or web shopping instructions to facilitate web shopping-related processes and functions. In some implementations, the media processing instructions 566 are divided into audio processing instructions and video processing instructions to facilitate audio processing-related processes and functions and video processing-related processes and functions, respectively. An activation record and International Mobile Equipment Identity (IMEI) 574 or similar hardware identifier can also be stored in memory 550.

Each of the above identified instructions and applications can correspond to a set of instructions for performing one or more functions described above. These instructions need not be implemented as separate software programs, procedures, or modules. The memory 550 can include additional instructions or fewer instructions. Furthermore, various functions of the mobile device 100 may be implemented in hardware and/or in software, including in one or more signal processing and/or application specific integrated circuits.

### Example Network Operating Environment

FIG. 6 is a block diagram of an example network operating environment 600. In FIG. 6, mobile devices 602a and 602b each can represent mobile device 100. Mobile devices 602a and 602b can, for example, communicate over one or more wired and/or wireless networks 610 in data communication. For example, a wireless network 612, e.g., a cellular network, can communicate with a wide area network (WAN) 614, such as the Internet, by use of a gateway 616. Likewise, an access device 618, such as an 802.11g wireless access device, can provide communication access to the wide area network 614. In some implementations, both voice and data communications can be established over the wireless network 612 and the access device 618. For example, the mobile device 602a can place and receive phone calls (e.g., using VoIP protocols), send and receive e-mail messages (e.g., using POP3 protocol), and retrieve electronic documents and/or streams, such as web pages, photographs, and videos, over the wireless network 612, gateway 616, and wide area network 614 (e.g., using TCP/IP or UDP protocols). Likewise, in some implementations, the mobile device 602b can place and receive phone calls, send and receive e-mail messages, and retrieve electronic documents over the access device 618 and the wide area network 614. In some implementations, the mobile device 602a or 602b can be physically connected to the access device 618 using one or more cables and the access device 618 can be a personal computer. In this configuration, the mobile device 602a or 602b can be referred to as a “tethered” device.

The mobile devices 602a and 602b can also establish communications by other means. For example, the wireless device 602a can communicate with other wireless devices, e.g., other mobile devices 602a or 602b, cell phones, etc., over the wireless network 612. Likewise, the mobile devices 602a and 602b can establish peer-to-peer communications 620, e.g., a personal area network, by use of one or more communication subsystems, such as the Bluetooth™ communication devices 188 shown in FIG. 1. Other communication protocols and topologies can also be implemented.

The mobile device 602a or 602b can, for example, communicate with one or more services 630, 640, 650, 660, and 670 over the one or more wired and/or wireless networks 610. For example, a navigation service 630 can provide navigation information, e.g., map information, location information, route information, and other information, to the mobile device 602a or 602b.

A messaging service 640 can, for example, provide e-mail and/or other messaging services. A media service 650 can, for example, provide access to media files, such as song files, audio books, movie files, video clips, and other media data. In some implementations, separate audio and video services (not shown) can provide access to the respective types of media files. A syncing service 660 can, for example, perform syncing services (e.g., sync files). An activation service 670 can, for example, perform an activation process for activating the mobile device 602a or 602b. Other services can also be provided, including a software update service that automatically determines whether software updates exist for software on the mobile device 602a or 602b, then downloads the software updates to the mobile device 602a or 602b where the software updates can be manually or automatically unpacked and/or installed.

The mobile device 602a or 602b can also access other data and content over the one or more wired and/or wireless networks 610. For example, content publishers, such as news sites, RSS feeds, web sites, blogs, social networking sites, developer networks, etc., can be accessed by the mobile device 602a or 602b. Such access can be provided by invocation of a web browsing function or application (e.g., a browser) in response to a user touching the Web object 114.

It should be appreciated that while the implementations described above are described in reference to a mobile device, the described implementations can be implemented on any device, mobile or not, that has a relatively small display screen.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims.

What is claimed is:

1. A method comprising:
presenting a user interface on a mobile device for displaying currently playing content;
obtaining a first touch input through the user interface; and
responsive to the first touch input, overlaying a partially transparent sheet on the user interface, the sheet including one or more options associated with the currently playing content.

2. The method of claim 1, further comprising:
obtaining a second touch input through the user interface; and
scrolling the sheet based on the second input.

3. The method of claim 2, where the second touch input is a gesture using one or more fingers.

4. The method of claim 1, further comprising:
overlaying one or more controls on the user interface which are operable through touch input to control the content.

5. The method of claim 4, where the one or more controls are included in a partially transparent panel overlying the user interface, so that the content is at least partially visible through the panel.

6. The method of claim 1, where one option is to select a language for an audio portion of the content.

7. The method of claim 1, where one option is to select a language for subtitles or closed captions.

8. The method of claim 1, further comprising:
obtaining user input through the user interface specifying selection of a language; and
enabling the selected language for the currently playing content.

9. The method of claim 8, further comprising:
setting the selected language to be a default language for the mobile device.

10. The method of claim 1, further comprising:
pausing the content.

11. The method of claim 1, where the content includes video content.

12. A system comprising:
one or more processors;
a computer-readable medium coupled to the one or more processors and including instructions, which when executed by the one or more processors, causes the one or more processors to perform operations comprising:
presenting a user interface on a mobile device for displaying currently playing content;
obtaining a first touch input through the user interface; and
responsive to the first touch input, overlaying a partially transparent sheet on the user interface, the sheet including one or more options associated with the currently playing content.

13. The system of claim 12, further comprising:
obtaining a second touch input through the user interface; and
scrolling the sheet based on the second input.

14. The system of claim 13, where the second touch input is a gesture using one or more fingers.

15. The system of claim 12, further comprising:
overlaying one or more controls on the user interface which are operable through touch input to control the content.

16. The system of claim 15, where the one or more controls are included in a partially transparent panel overlying the user interface, so that the content is at least partially visible through the panel.

17. The system of claim 12, where one option is to select a language for an audio portion of the content.

18. The system of claim 12, where one option is to select a language for subtitles or closed captions.

19. The system of claim 12, further comprising:
obtaining user input through the user interface specifying selection of a language; and
enabling the selected language for the currently playing content.

20. The system of claim 19, further comprising:
setting the selected language to be a default language for the mobile device.

21. The system of claim 12 further comprising:
pausing the content.

22. The system of claim 12, where the content includes video content.

23. A computer-readable medium having instructions stored thereon, which, when executed by one or more processors, causes the one or more processors to perform operations comprising:
presenting a user interface on a mobile device for displaying currently playing content;
obtaining a first touch input through the user interface; and
responsive to the first touch input, overlaying a partially transparent sheet on the user interface, the sheet including one or more options associated with the currently playing content.

24. A method comprising:
presenting a user interface on a mobile device for displaying currently playing content;
obtaining touch input through the user interface;
responsive to the touch input,
presenting language options; and
detecting a language selection.

25. A computer-readable medium having instructions stored thereon, which, when executed by one or more processors, causes the one or more processors to perform operations comprising:
presenting a user interface on a mobile device for displaying currently playing content;
obtaining touch input through the user interface;
responsive to the touch input,
presenting language options; and
detecting a language selection.
